(19) United States
(12) Patent Application Publication
(10) Pub. No.: US 2010/0121065 A1
(43) Pub. Date: May 13, 2010

(54) Phosphors with High Luminous Efficiency and Display Device Containing Them

(75) Inventors: So-Young Jung, Seoul (KR); Kyu-Sung Cho, Suwon (KR); Kyung-Hoon Choi, Seoul (KR); No-Gill Park, Seoul (KR); Bong-Ok Kim, Seoul (KR); Sung-Min Kim, Seoul (KR); Seung-Soo Yoon, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: GRACEL DISPLAY INC., Seoul (KR)

(21) Appl. No.: 11/814,132

(22) PCT Filed: Jan. 17, 2006
(86) PCT No.: PCT/KR06/00179

§ 371 Date: Jul. 17, 2007

(30) Foreign Application Priority Data
Jan. 17, 2005 (KR) 10-2005-0004339

(51) Int. Cl. C07F 15/00

(52) U.S. Cl. 546/4

(57) ABSTRACT

The present invention relates to a novel organic electrophosphorescent compounds and a display device comprising the same. The electroluminescent iridium compounds described above can be employed as a light emitting substance having a molecular structure which gives high efficiency in a blue phosphor material.

### TECHNICAL FIELD

The present invention relates to electroluminescent iridium compounds and display devices employing the same as a light emitting dopant. More specifically, it relates to novel iridium compounds which have blue electroluminescent property of high efficiency and can be used as a substance to form a light emitting layer of a light emitting device, and display devices employing the compounds as a light emitting dopant.

### BACKGROUND ART

Among display devices, electroluminescence (EL) devices, being self-luminous type display devices, have advantages of wide visual angle, excellent contrast as well as rapid response rate.

Meanwhile, Eastman Kodak firstly developed an organic EL device employing low molecular aromatic diamine and aluminum complex as a substance for forming a light emitting layer, in 1987 [App]. Phys. Lett. 51, 913, 1987].

The most important factor to determine luminous efficiency in an organic EL device is light emitting material. Though fluorescent materials have been widely used up to the present as the light emitting material, development of phosphor material, from the aspect of the mechanism of electroluminescence, is one of the best ways to improve the luminous efficiency up to 4 folds, theoretically.

Up to the present, iridium (III) complexes have been widely known as phosphorescent light emitting material: (acac)Ir(btp)₂, Ir(ppy)₃ and Firpic or the like having been known as RGB, respectively [Baldo et al., Appl. Phys. Lett., Vol 75, No. 1, 4, 1999; WO 00/70 655; WO 02/7 492; Korean Patent Laid-Open No. 2004-14346]. Various phosphors have been researched in Japan, Europe and Americal, in particular.

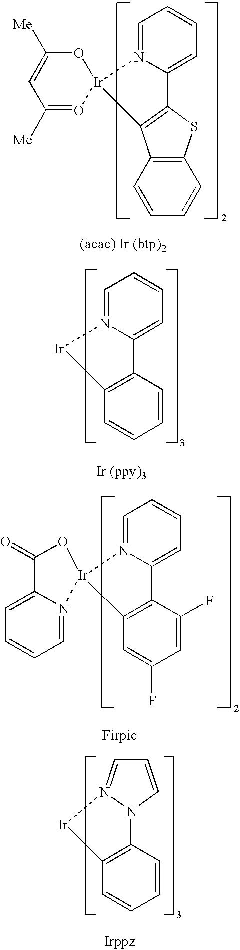

Though a few excellent conventional iridium complexes have been reported for red light emitting substances or green light emitting substances up to the present, only Firpic or Irppz represented by the Formulas above has been reported as a possible substance for blue light emitting substance. However, the technical level is an early stage for mass production because the compounds have considerably short lifetime as compared to other light emitting substances. In particular, the possibility of mass production of a blue phosphor is very low unless a host which can lead maximum performance of the blue phosphors is developed.

### DISCLOSURE

### Technical Problem

The object of the present invention is to overcome above-mentioned problems and to provide a blue phosphor compound having quite different concept from conventional blue phosphors. Other objects of the present invention are to provide a phosphor compound which has excellent lifetime compared to conventional blue phosphor compounds so that it is advantageous to be commonly employed, and has light emitting property of high efficiency even in a low doping concentration, and to provide a display device employing the novel blue phosphor compound as a light emitting dopant.

### Technical Solution

As a result of intensive researches to solve the problems of prior art, the present inventors invented blue electroluminescent compounds having light emitting property of high efficiency even in a low doping concentration, and a display device employing the compound as a light emitting dopant.

The present invention relates to a phosphor compound represented by Chemical Formula 1:

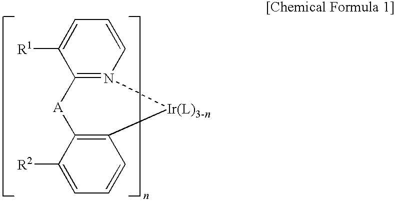

wherein, L is selected from the ligands of following formulas:

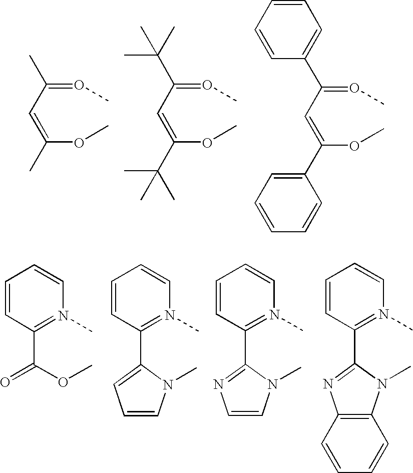

n is 2 or 3, A is selected from the groups of following formulas:

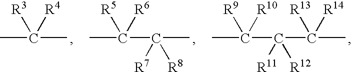

R¹ or R² independently represents hydrogen, linear or branched C₁-C₂₀ alkyl group or alkoxy group with or without halogen substituent(s), halogen or cyano group; each one of groups from R³ to R¹⁴ independently represents hydrogen, linear or branched C₁-C₂₀ alkyl group or alkoxy group with or without halogen substituent(s), halogen, phenyl group, ketone group, cyano group or C₅-C₇ cycloalkyl, or groups from R³ to R¹⁴ are linked via alkylene or alkenylene each other to form a C₅-C₇ Spiro-ring or a C₅-C₉ fused ring, or linked with R¹ or R² via alkylene or alkenylene to form a C₅-C₇ fused ring.

The novel iridium complexes according to the present invention are blue electroluminescent compounds having excellent lifespan and light emitting properties with high efficiency even in low doping concentration.

Novel phosphor compounds according to the present invention (compounds of Chemical Formula 1) include compounds having the structures of Chemical Formula 2 to Chemical Formula 4:

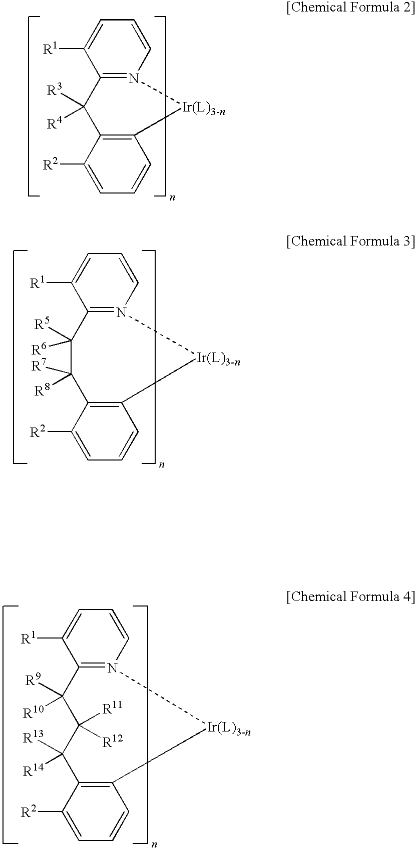

In the compounds of Chemical Formula 2 to Chemical Formula 4, R¹ or R² independently represents hydrogen, methyl, ethyl or halogen; each one of groups from R³ to R¹⁴ independently represents hydrogen, linear or branched C₁-C₅ alkyl, halogen, or groups from R³ to R¹⁴ are linked each other via alkylene or alkenylene to form a C₅-C₆ spiro-ring or a C₅-C₉ fused ring, or linked with R¹ or R² via alkylene or alkenylene to form a C₅-C₆ fused ring.

The compounds represented by Chemical Formula 2 include compounds represented by one of Chemical Formulas 5 to 9:

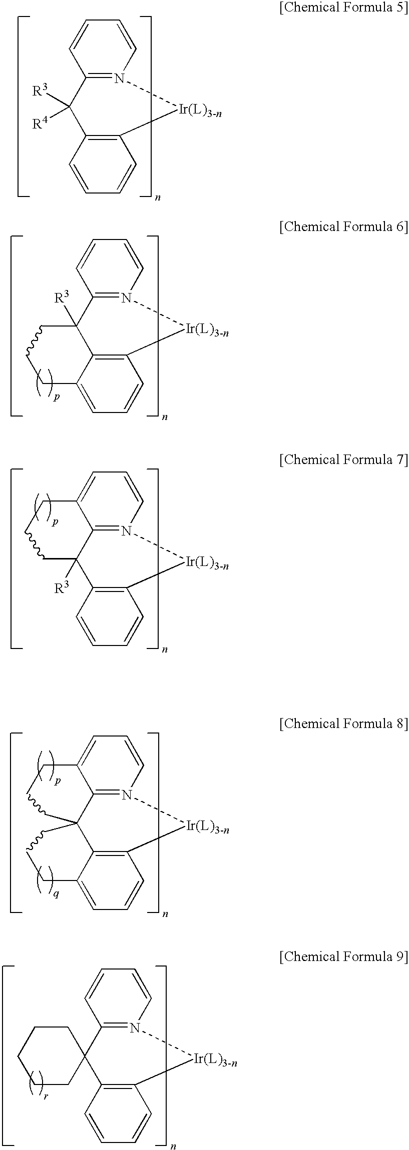

In the Chemical Formulas 5 to 7, R³ and R⁴ independently represent hydrogen, methyl, ethyl, n-propyl, i-propyl or fluorine, p, q or r represents 1 or 2, and the dotted line means a single bond or a double bond.

The compounds represented by Chemical Formula 3 include compounds represented by one of Chemical Formulas 10 to 15:

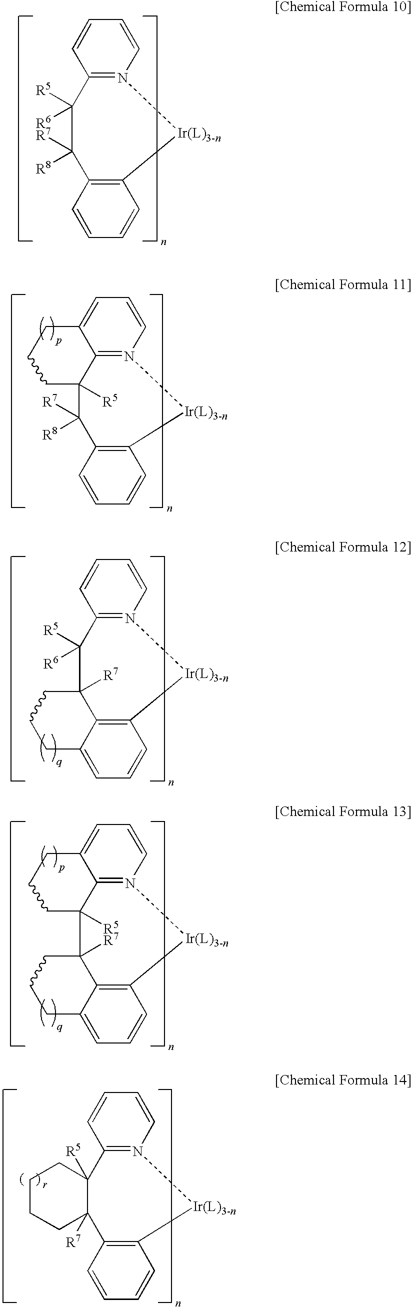

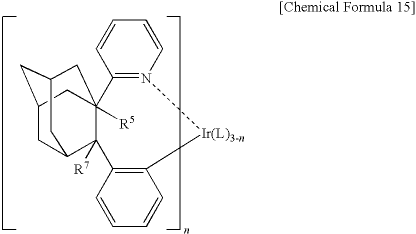

In the Chemical Formulas 10 to 15, R⁵ to R⁸ independently represent hydrogen, methyl, ethyl, n-propyl, i-propyl or fluorine, p, q or r represents 1 or 2, and the dotted line means a single bond or a double bond.

The compounds represented by Chemical Formula 4 include compounds represented by one of Chemical Formulas 16 to 21:

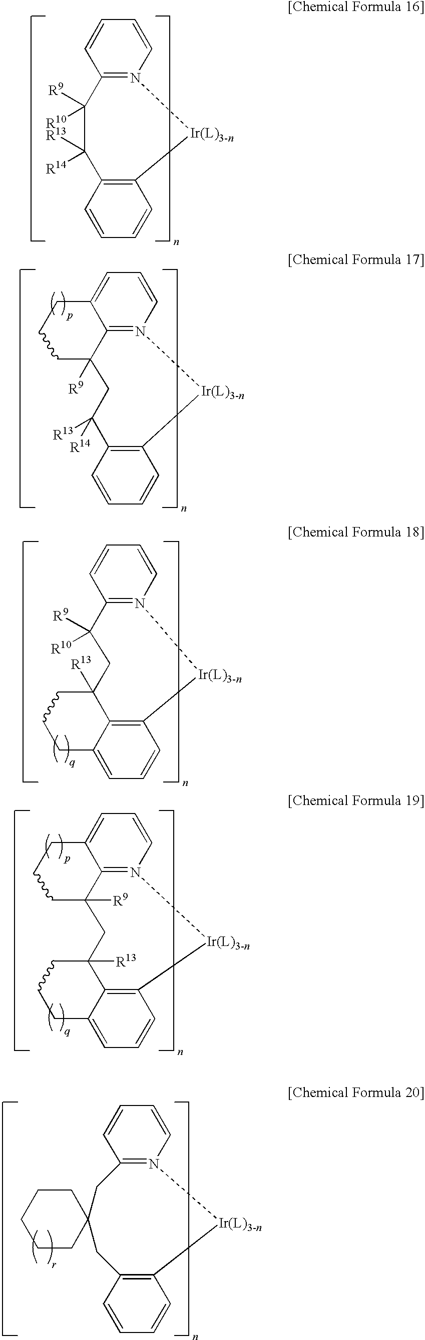

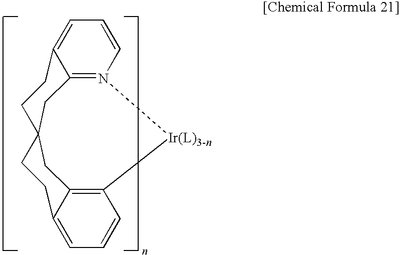

In the Chemical Formulas 16 to 21, R⁹ to R¹⁴ independently represent hydrogen, methyl, ethyl, n-propyl, i-propyl or fluorine, p, q or r represents 1 or 2, and the dotted line means a single bond or a double bond.

The novel electroluminescent compound according to the present invention is specifically selected from the compounds represented by following formulas:

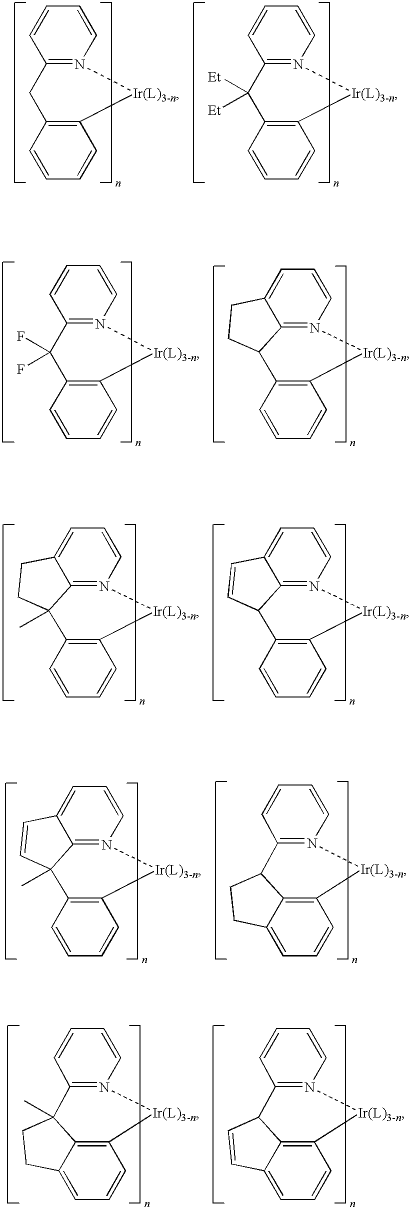

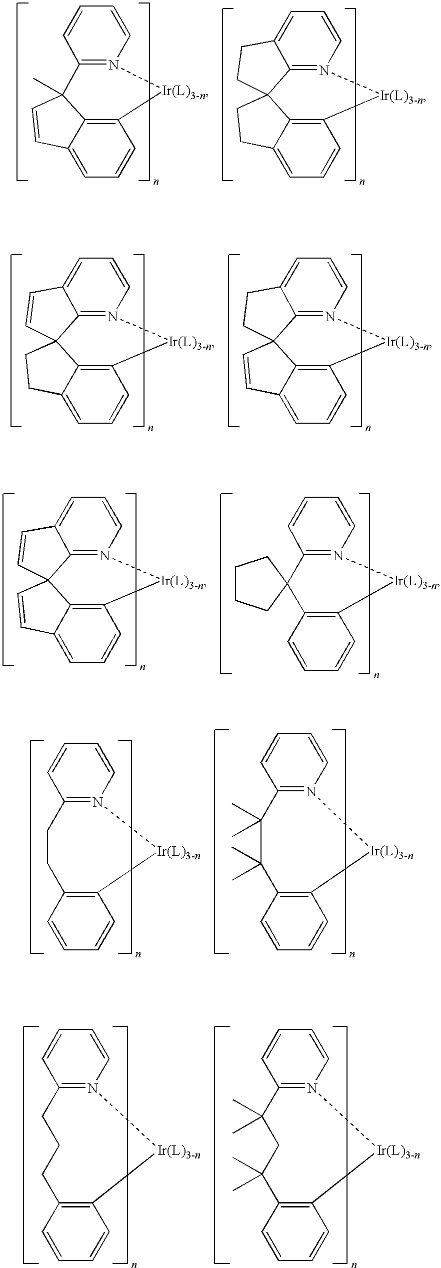

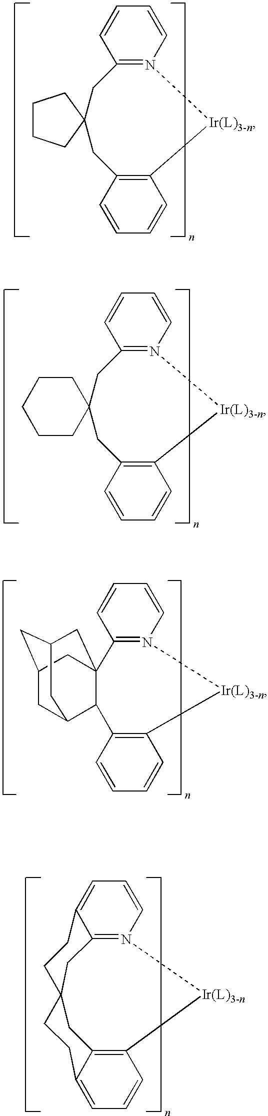

Since phosphors are very delicate in terms of lifespan, in general, tris-chelated complexes in which n is 3 is preferred according to the present invention. However, possible structure of the phosphor may have one or more auxiliary ligand(s) (that is, n=1 or 2), of which following auxiliary ligands are preferable.

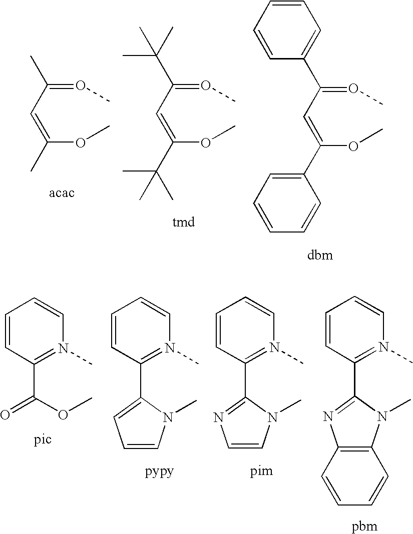

The pyridinyl derived ligands which constitute the electroluminescent compounds according to the present invention can be prepared by adopting the preparation process illustrated in Reaction Scheme 1 to Reaction Scheme 4:

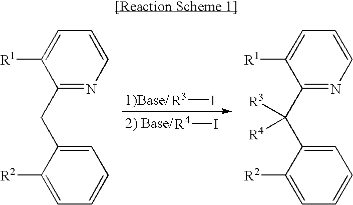

As shown in Reaction Scheme 1, the ligand can be prepared by deleting the activated hydrogen at the benzyl position from a benzylpyridine derivative, as an easily available starting material, and substituting it with halogenated alkyl or the like.

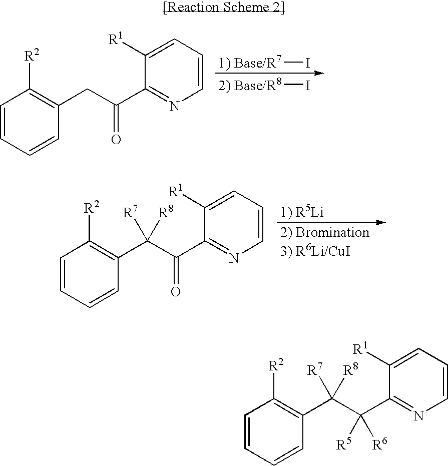

As illustrated by Reaction Scheme 2, the ligand can be prepared by replacing a substituent at the activated benzyl position of 2-phenyl-1-pyridin-2-yl-ethanone or 2-phenyl-1-pyridin-2-yl-propanone as a starting material, subjecting it to a nucleophilic reaction with alkyl lithium or the like, converting the hydroxyl group of the resultant compound to a leaving group, and performing a coupling reaction. Alternatively, the corresponding pyridinyl derived ligand can be prepared by directly removing the carbonyl group of said ethanone derivative by using a reductant such as lithium aluminum hydride.

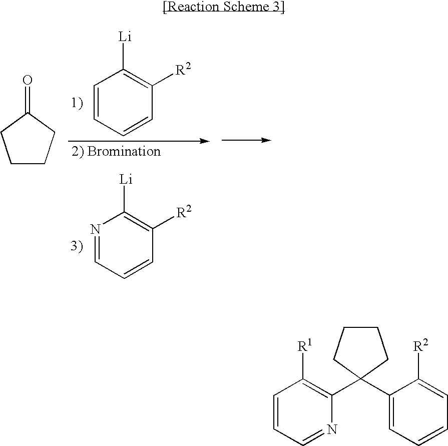

As shown in Reaction Scheme 3, a pyridinyl derived compound containing a corresponding spiro ring can be prepared from cyclopropanone via nucleophilic reaction or substitution with phenyl lithium and a 2-lithiated pyridine derivative.

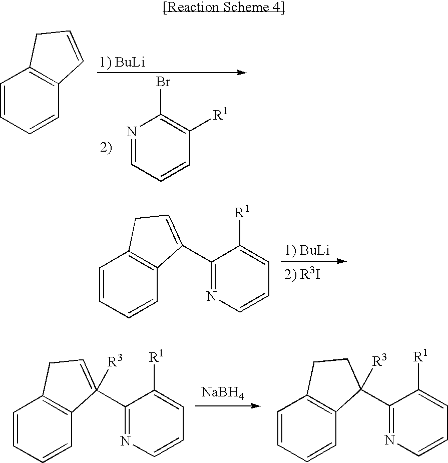

The compound which forms a fused ring with a phenyl group or a pyridine group can be prepared, as illustrated in Reaction Scheme 4, by deleting the activated hydrogen at the benzyl position of 1H-indene as starting material and performing a coupling reaction with bromobenzene or the like.

The process for preparing novel pyridinyl derived ligands according to the present invention is not restricted to one of the processes illustrated by Reaction Schemes 1 to 4. In addition, one of the processes according to Reaction Scheme 1 to Reaction Scheme 4 may be adapted, or any preparing process via other route may be carried out. Since the preparation can be performed without difficulties by a person having ordinary skill in the art by using conventional methods of organic synthesis, it is not described here in detail.

From the novel pyridinyl derived ligands, iridium complexes can be prepared via the process of Reaction Scheme 5:

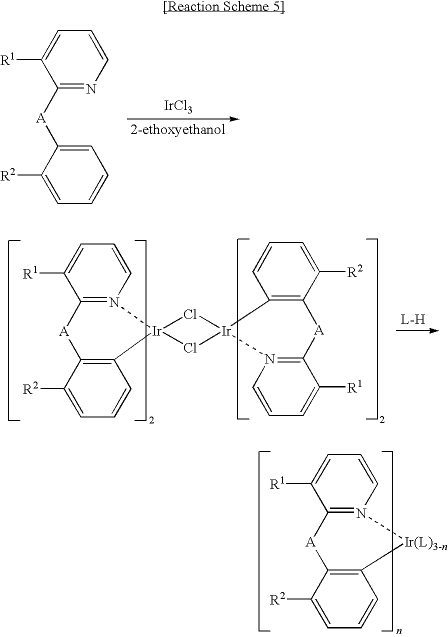

Iridium trichloride (IrCl₃) and the pyridinyl derived ligand thus prepared are mixed in a molar ratio of 1:2˜3, preferably in a molar ratio of about 1:2.2 in the presence of a solvent and the mixture is heated under reflux to isolate diiridium dimer. The solvent used in this reaction stage is preferably alcohol or alcohol/water mixed solvent, for example 2-ethoxyethanol or 2-ethoxyethanol/water mixed solvent.

The isolated diiridium dimer is mixed with auxiliary ligand L and organic solvent and heated to prepare electroluminescent iridium compound as the final product. The molar ratio of pyridinyl derived ligand and other ligand L to be reacted is determined according to the composition ratio of the final product. At this time, AgCF₃SO₃, Na₂CO₃, NaOH or the like is reacted as being mixed with 2-ethoxyethanol or diglyme as organic solvent.

### DESCRIPTION OF DRAWINGS

FIG. 1 is a cross-sectional view of an organic EL device,

FIG. 2 is an electroluminescence spectrum of a mCP:[B01(M)-0] complex,

FIG. 3 is a graph showing the property of current density-voltage-luminance of a mCP:[B01(M)-0] device,

FIG. 4 is a graph showing the property of luminance-voltage-luminance of a mCP:[B01(M)-0] device, and

FIG. 5 is a graph showing the property of luminous efficiency of a mCP:[B01(M)-0] device.

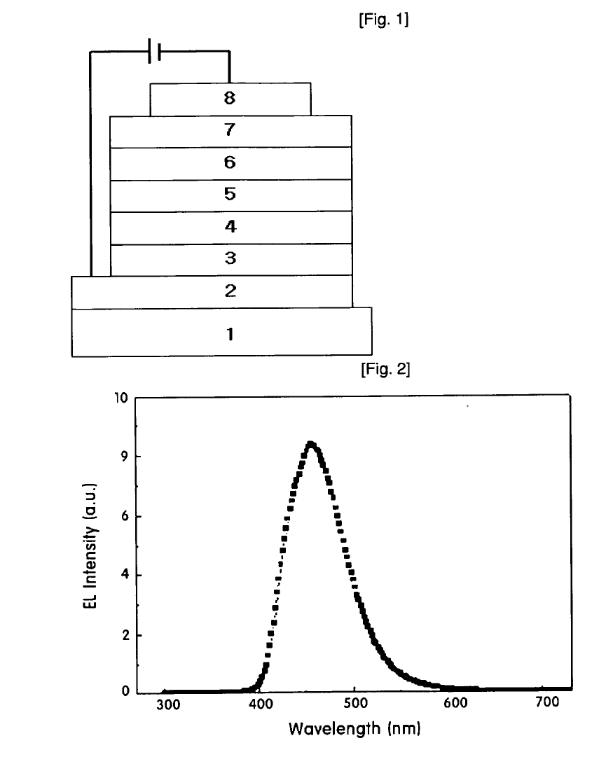

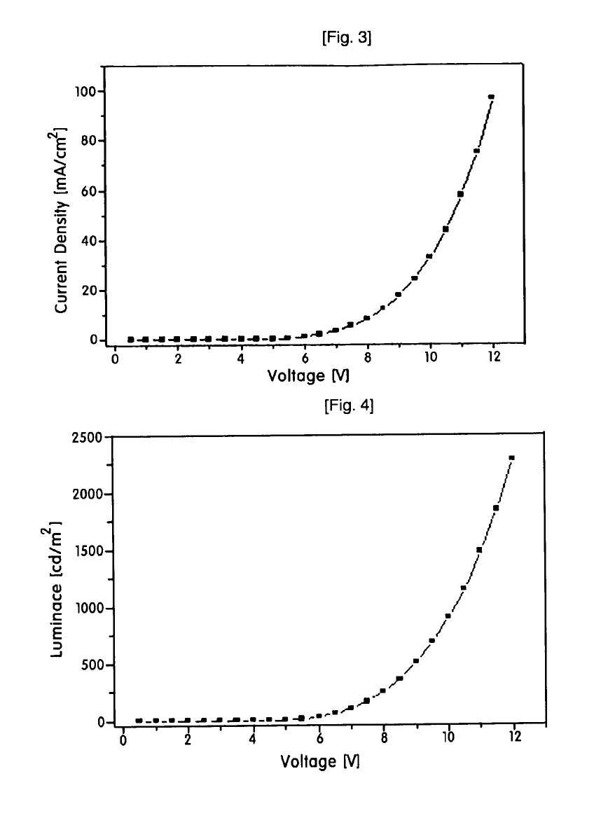

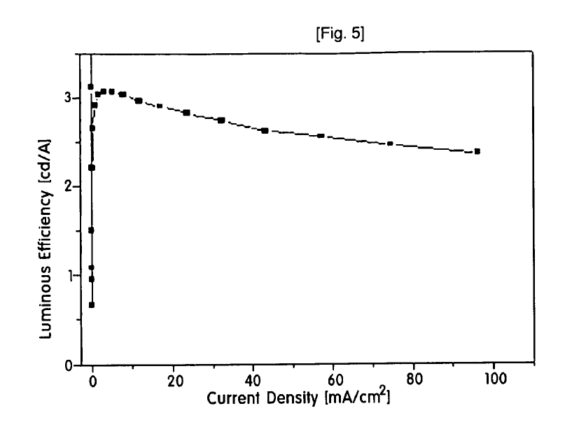

### DESCRIPTION OF SYMBOLS OF SIGNIFICANT PARTS OF THE DRAWINGS

1: a glass for organic EL
2: a transparent electrode ITO thin film
3: a hole transport layer
4: a light emitting layer
5: a hole blocking layer
6: an electron transport layer
7: an electron injecting layer
8: a cathode

Other and further objects, features and advantages of the invention will appear more fully from the following description.

### MODE FOR INVENTION

Now, the present invention is described as referring to exemplary processes for preparing the novel electroluminescent compounds according to the present invention by way of Examples. These Examples, however, are intended to provide better understanding of the invention, and it should be understood that the scope of the invention is not restricted thereto.

### EXAMPLES

The ligands employed in the following Examples are designated as abbreviations as defined in Table 1:

TABLE 1

| Abbrev. | Ligand |
|---|---|
| B01 | 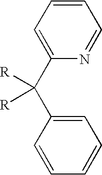 |
| B02 | 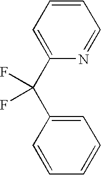 |
| B03 | 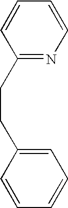 |
| B04 | 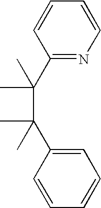 |
| B05 | 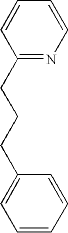 |
| B06 | 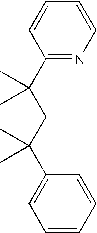 |
| B07 | 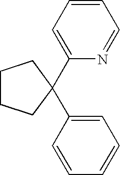 |
| B08 | 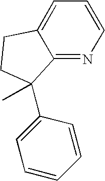 |
| B09 | 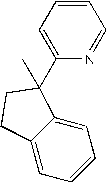 |
| B10 | 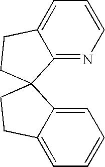 |
| B11 | 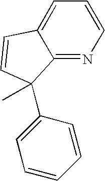 |
| B12 | 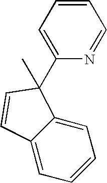 |
| B13 | 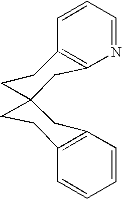 |
| B14 | 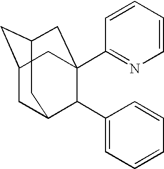 |

### Example 1

### Preparation of [B01(R=H)]₃Ir

Iridium chloride (III) (0.40 g, 1.37 mmol) and benzyl pyridine (purchased from Aldrich) as ligand B01 (R=H) (0.90 g, 5.33 mmol) were added to 20 mL of 2-ethoxyethanol, and the mixture was heated under reflux under nitrogen atmosphere for 16 hours. At ambient temperature, water (50 mL) was poured into the reaction mixture, and the solid produced was filtered and washed with cold methanol to give μ-dichloro diiridium intermediate (0.52 g, yield: 45%) as yellow crystals.

To 5 mL of diglyme, added were μ-dichloro diiridium intermediate (0.52 g, 0.31 mmol) thus obtained, ligand B01 (R=H) (0.12 g, 0.73 mmol) and AgCF₃SO₃ (0.19 g), and the resultant mixture was heated at 110° C. under nitrogen atmosphere for 24 hours. At ambient temperature, 50 mL of water was poured thereto. After filtering the solid produced, extracting with methylene chloride, and recrystallizing from a mixed solution of methylene chloride-methanol, 0.11 g (yield: 20%) of title compound was obtained.

¹H NMR (200 MHz, CDCl₃): δ 0.2 (s, 6H), 7.05-7.3 (m, 18H), 7.6-7.9 (m, 6H)

MS/FAB: 700 (found), 699.88 (calculated)

### Example 2

### Preparation of [B01(R=methyl)]₃Ir

Benzyl pyridine (1.0 g, 5.9 mmol) was dissolved in 20 mL of THF under nitrogen atmosphere, and phenyl lithium solution (6.5 mmol) was added thereto at −78° C. After standing for 20 minutes, methyl iodide (0.92 g, 6.5 mmol) together with 5 mL of THF was slowly added to the reaction mixture, and the resultant mixture was stirred for one hour. The reaction temperature was raised to room temperature, and the mixture stirred for 2 hours. After quenching the reaction, the product was extracted to obtain 0.86 g of the product having a methyl substituent as oil. Methyl substituted product thus obtained (0.86 g, 4.7 mmol) was again dissolved in 20 mL of THF under nitrogen atmosphere, and reacted with phenyl lithium and methyl iodide in the same manner. After purification by silica gel column chromatography, pure benzyl pyridine having two methyl substituents at the benzyl position (B01(R=methyl)) (0.61 g, 3.1 mmol, yield: 53%) was obtained.

By using dimethyl ligand B01(R=methyl) (0.61 g, 3.1 mmol) thus obtained, the same procedure as described in Example 1 was repeated to give the title compound, tri-chelated iridium complex (0.31 g, 0.40 mmol, yield: 39%).

B01(R=methyl)

¹H NMR (200 MHz, CDCl₃): δ 1.65 (s, 6H), 7.05-7.23 (m, 7H), 7.62-7.7 (q, 1H), 8.62 (d, 1H) [B01(R=methyl)]₃Ir

¹H NMR (200 MHz, CDCl₃): δ 1.7 (s, 18H), 7.05-7.3 (m, 18H), 7.6-7.9 (m, 6H)

MS/FAB: 785 (found), 784.05 (calculated)

### Example 3

### Preparation of [B01(R=ethyl)]₃Ir

By using ethyl iodide, the same procedure as described in Example 2 was repeated to give the title compound, diethyl ligand B01 (R=ethyl) (yield: 46%).

By the use of dimethyl ligand B01 (R=ethyl) (0.8 g, 3.55 mmol) thus obtained, the same procedure as described in Example 1 was repeated to give tri-chelated iridium complex (0.37 g, 0.43 mmol, yield: 36%).

B01(R=ethyl)

¹H NMR (200 MHz, CDCl₃): δ 1.0 (t, 6H), 1.9 (q, 4H), 7.05-7.23 (m, 7H), 7.62-7.7 (q, 1H), 8.62 (d, 1H)

[B01(R=ethyl)]₃Ir

¹H NMR (200 MHz, CDCl₃): δ 0.95 (t, 18H), 1.9 (q, 12H), 7.05-7.3 (m, 18H), 7.6-7.9 (m, 6H)

MS/FAB: 869 (found), 868.21 (calculated)

### Example 4

### Preparation of [B03]₃Ir

In 20 mL of ether, 2-phenyl-1-pyridin-2-yl-ethanone (1.0 g, 5.07 mmol) was dissolved, and lithium aluminum hydride (1.0 M solution in ether 10 mL) was slowly added thereto at −78° C. After stirring the reaction mixture for one hour or more, the temperature was raised to ambient temperature, and the reaction continued for two hours or more. After quenching by using ethanol and treatment of acid-base, ligand B03 (0.79 g, 4.31 mmol, yield: 85%) was obtained by extraction.

By the use of ligand B03 (0.79 g, 4.31 mmol) thus obtained, the same procedure as described in Example 1 was repeated to give tri-chelated iridium complex (0.35 g, 0.47 mmol, yield: 33%).

B03

¹H NMR (200 MHz, CDCl₃): δ 2.88 (t, 2H), 3.21 (t, 2H), 7.05-7.23 (m, 7H), 7.62-7.7 (q, 1H), 8.62 (d, 1H)

[B03]₃Ir

¹H NMR (200 MHz, CDCl₃): δ 2.9 (t, 6H), 3.22 (t, 6H), 7.05-7.3 (m, 18H), 7.6-7.9 (m, 6H)

MS/FAB: 742 (found), 741.97 (calculated)

### Example 5

### Preparation of [B07]₃Ir

Cyclopentanone (2.1 g, 25.0 mmol) and 1.1 equivalent of phenyl lithium (2.75 mmol) were added to THF solvent at −78° C., and the temperature was raised to ambient temperature, to carry out the reaction for 2 to 4 hours. Again, at a temperature of −78° C., 2-lithiated pyridine (27.5 mmol, 1.1 equivalent) was added. After reacting for 2 to 4 hours as raising the temperature to ambient temperature, ligand B07 (1.2 g, yield: 21%) was obtained.

By the use of ligand B07 (1.0 g, 4.48 mmol) thus obtained, the same procedure as described in Example 1 was repeated to give tri-chelated iridium complex (0.54 g, 0.63 mmol, yield: 42%).

B07

¹H NMR (200 MHz, CDCl₃): δ 1.5 (t, 4H), 2.1 (t, 4H), 7.05-7.3 (m, 5H), 7.5-7.7 (m, 2H), 8.6 (d, 1H)

[B07]₂Ir

¹H NMR (200 MHz, CDCl₂): δ 1.5 (t, 12H), 2.1 (t, 12H), 7.05-7.3 (m, 18H), 7.6-7.9 (m, 6H)

MS/FAB: 863 (found), 862.16 (calculated)

### Example 6

### Preparation of [B09]₂[acac]Ir

Under nitrogen atmosphere, 1H-indene (1.0 g, 8.6 mmol) was dissolved in 20 mL of THF, and n-butyl lithium (2.0 M solution in hexane 5 mL) was added thereto at −78° C. After standing for 20 minutes, 2-bromopyridine (1.4 g, 8.86 mmol) together with 5 mL of THF was slowly added to the reaction mixture, and the resultant mixture was stirred for one hour. The reaction temperature was raised to room temperature, and the mixture stirred for 2 hours. After quenching the reaction, the product was extracted to obtain indene having a pyridinyl substituent as oil. Pyridinyl indene thus obtained was again dissolved in THF, and reacted with n-butyl lithium (10 mmol) and methyl iodide (1.3 g, 9.2 mmol) at −78° C. under nitrogen atmosphere in the same manner, to prepare pyridinyl indene (B12) having a methyl substituent. The ligand (B12) thus prepared was reacted with excess amount of sodium borohydride in the presence of ethanol, to give ligand (B09). After purification by silica gel column chromatography, pure ligand (B09) (0.63 g, 3.0 mmol, yield: 35%) was obtained.

By using ligand B09 (0.63 g, 3.0 mmol) thus obtained, the same procedure as described in Example was repeated to give μ-dichloro diiridium intermediate, which was then dissolved in 10 mL of 2-ethoxyethanol and reacted with 2,4-pentanedione at 130° C. for 12 hours, to obtain the title compound (0.03 g, 0.035 mmol, yield: less than 5%).

B09

¹H NMR (200 MHz, CDCl₃): δ 1.5 (t, 4H), 2.1 (t, 4H), 7.05-7.3 (m, 5H), 7.5-7.7 (m, 2H), 8.6 (d, 1H)

[B09]₂[acac]Ir

¹H NMR (200 MHz, CDCl₃): δ 1.5 (t, 12H), 2.1 (t, 12H), 7.05-7.3 (m, 18H), 7.6-7.9 (m, 6H)

MS/FAB: 863 (found), 862.16 (calculated)

### Example 7

### Manufacture of OLED

An OLED device is manufactured by using the light emitting substance prepared from one of Examples 1 to 6 as a light emitting dopant.

A transparent electrode ITO thin film (150Ω/□) obtained from glass for OLED (manufactured from Samsung-Corning) was subjected to ultrasonic washing sequentially with trichloroethylene, acetone, ethanol and distilled water, and stored in isopropanol.

Then, an ITO substrate is equipped on a substrate folder of vacuum vapor deposition device, and 4,4′,4″-tris(N,N-(2-naphthyl)-phenylamino)triphenylamine (2-TNATA) was charged in a cell of the vacuum vapor deposition device. After ventilation to reach the degree of vacuum in the chamber of 10⁻⁶ torr, electric current was applied to the cell to evaporate 2-TNATA to vapor-deposit a hole injecting layer on the ITO substrate with 60 nm of thickness.

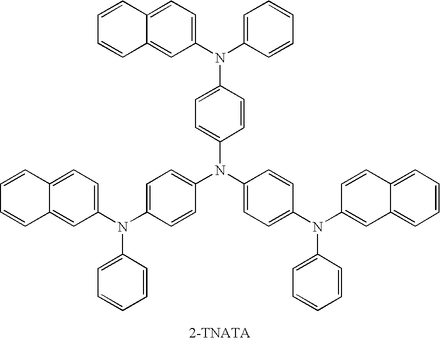

Then, N,N′-bis(α-naphthyl)-N,N′-diphenyl-4,4′-diamine (NPB) was charged in another cell of said vacuum vapor deposition device, and electric current was applied to the cell to evaporate NPB to vapor-deposit a hole transport layer on the hole injecting layer with 20 nm of thickness.

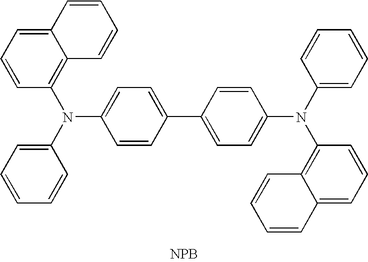

Further, 4,4′-N,N′-dicarbazole-biphenyl (CBP) as a light emitting host substance was charged in another cell of the vacuum vapor deposition device, while the light emitting substance prepared from each one of Examples 1 to 6 in still another cell. The two substances were doped by evaporating them in different rates, to vapor deposit a light emitting layer (4) having 30 nm of thickness on the hole transport layer.

The doping concentration of 4 to 10 mol % was appropriate on the basis of CBP. Besides CBP, 1,3-bis(N-carbazolyl)benzene (mCP) or 4,4′-N,N′-dicarbazole-3,3′-dimethyl-biphenyl (CDBP) was employed as a light emitting host substance, depending upon the EL light emitting wavelength. The doping concentration of 4 to 10% was again appropriate.

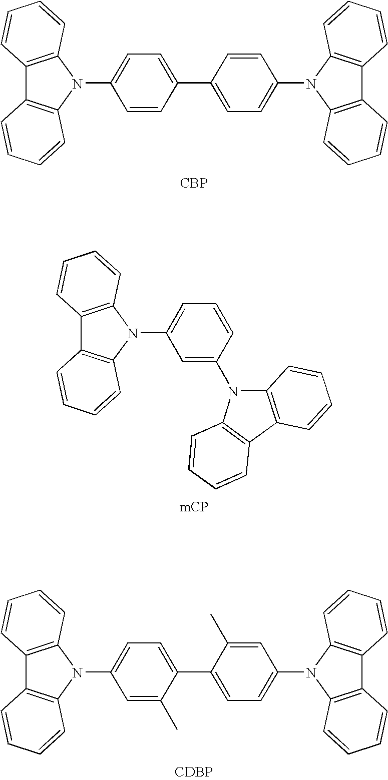

Then, in the same manner as in the case of NPB, bis(2-methyl-8-quinolinato)(p-phenylphenolato)aluminum (III) (BAlq) as a hole blocking layer was vapor deposited with a thickness of 10 nm on the light emitting layer, and subsequently tris(8-hydroxyquinoline)aluminum (III) (Alq) as an electron transport layer was vapor deposited with a thickness of 20 nm. Lithium quinolate (Liq) as an electron injecting layer was then vapor deposited with a thickness of 1 to 2 nm, and Al cathode was vapor deposited with a thickness for 150 nm by using another vapor deposition device, to manufacture an OLED.

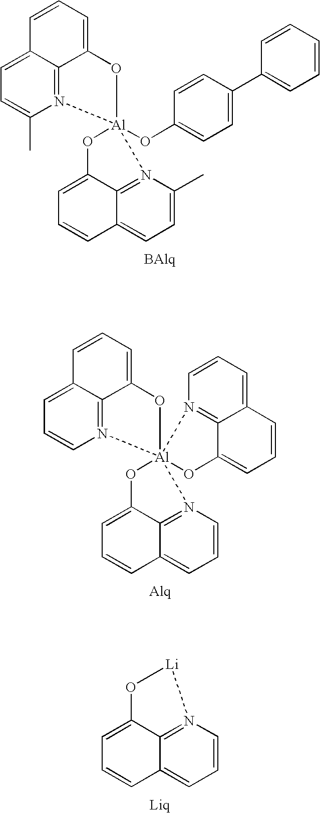

### Example 8

### Evaluation of Optical Properties of Light Emitting Substances

The complexes having high synthetic yield among the substances were purified by vacuum sublimation under 10⁻⁶ torr, and used as a dopant of an OLED light emitting layer. With respect to the substances having low synthetic yield, only the light emitting peak was checked. The light emitting peak was measured by preparing a methylene chloride solution having the concentration of 10⁻⁴ or less. At the time of measuring light emission of every substance, the excitation wavelength was 250 nm.

Luminous efficiencies of the OLEDs were measured at 10 mA/cm², and the properties of various electroluminescent compounds according to the present invention are shown in Table 2:

TABLE 2

| | | Light | | |
|---|---|---|---|---|
| | | emitting | Electro | Lumious |
| Compound | | wavelength | luminescence | efficiency |
| No. | Main Ligand | (nm) | wavelength (nm) | (cd/A) |
| 1 | [B01(R = H)]₃Ir | 432 | — | — |
| 2 | [B01(R = H)]₂[acac]Ir | 460 | 485 | 1.2 |
| 3 | [B01(R = methyl)]₃Ir | 440 | 456 | 3.0 |
| 4 | [B01(R = methyl)]₂[acac]Ir | 473 | 490 | 2.2 |
| 5 | [B01(R = methyl)]₂[tmd]Ir | 477 | 495 | 3.1 |
| 6 | [B01(R = methyl)]₂[dbm]Ir | 484 | 504 | 2.1 |
| 7 | [B01(R = methyl)]₂[pic]Ir | 466 | 474 | 1.9 |
| 8 | [B01(R = methyl)]₂[pypy]Ir | 436 | — | — |
| 9 | [B01(R = methyl)]₂[pim]Ir | 434 | — | — |
| 10 | [B01(R = methyl)]₂[pbm]Ir | 430 | 459 | 1.5 |
| 11 | [B01(R = ethyl)]₃Ir | 442 | 469 | 1.1 |
| 12 | [B02]₂[acac]Ir | 442 | — | — |
| 13 | [B03]₃Ir | 440 | 470 | 1.2 |
| 14 | [B05]₃Ir | 438 | 465 | 1.4 |
| 15 | [B07]₃Ir | 435 | 474 | 1.5 |
| 16 | [B09]₃₂[pic]Ir | 460 | 492 | — |
| 17 | [B09]₂[acac]Ir | 472 | 505 | — |
| 18 | [B12]₂[acac]Ir | 501 | 518 | 3.8 |

### INDUSTRIAL APPLICABILITY

As described above, the novel electroluminescent iridium complexes according to the present invention are those substances showing blue light emitting property, that have excellent lifespan, and light emitting properties of high efficiency even at a low doping concentration. The phosphors according to the present invention can prominently contribute to improve EL performance of organic EL devices, and particularly overcome the problem of absence of a blue substance, which has been an obstacle for selecting a phosphor.

1. A phosphor compound represented by Chemical Formula 1: 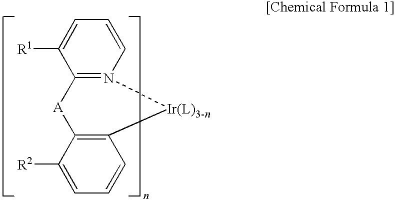
wherein, L is selected from the ligands of following formulas: 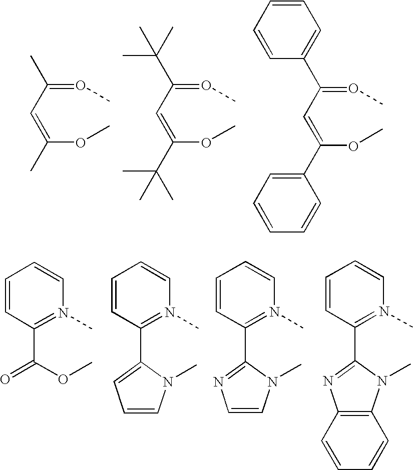
n is 2 or 3,
A is selected from the groups of following formulas: 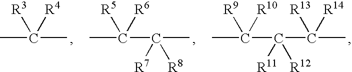
R¹ or R² independently represents hydrogen, linear or branched C₁-C₂₀ alkyl group or alkoxy group with or without halogen substituent(s), halogen or cyano group; each one of groups from R³ to R¹⁴ independently represents hydrogen, linear or branched C₁-C₂₀ alkyl group or alkoxy group with or without halogen substituent(s), halogen, phenyl group, ketone group, cyano group or C₅-C₇ cycloalkyl, or groups from R³ to R¹⁴ are linked via alkylene or alkenylene each other to form a C₅-C₇ spiro-ring or a C₅-C₉ fused ring, or linked with R¹ or R² via alkylene or alkenylene to form a C₅-C₇ fused ring.

2. A phosphor compound according to claim 1, which is represented by Chemical Formula 2: 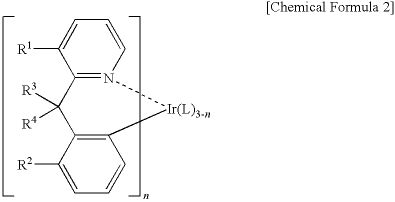
wherein R¹ or R² independently represents hydrogen, methyl, ethyl or halogen;
R³ or R⁴ independently represents hydrogen, linear or branched C₁-C₅ alkyl, halogen, or R³ and R⁴ are linked each other via alkylene or alkenylene to form a C₅-C₆ spiro-ring, or linked with R¹ or R² via alkylene or alkenylene to form a C₅-C₆ fused ring.

3. A phosphor compound according to claim 1, which is represented by Chemical Formula 3: 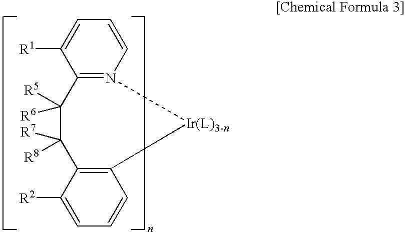
wherein R¹ or R² independently represents hydrogen, methyl, ethyl or halogen;
each one of groups from R⁵ to R⁸ independently represents hydrogen, linear or branched C₁-C₅ alkyl, halogen, or groups from R⁵ to R⁸ are linked each other via alkylene or alkenylene to form a C₅-C₆ spiro-ring or a C₅-C₉ fused ring, or linked with R¹ or R² via alkylene or alkenylene to form a C₅-C₆ fused ring.

4. A phosphor compound according to claim 1, which is represented by Chemical Formula 4: 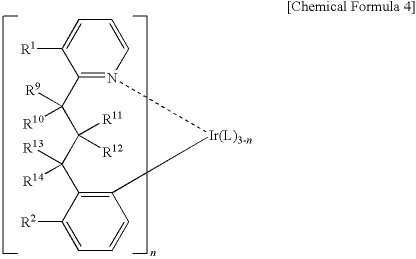
wherein R¹ or R² independently represents hydrogen; methyl, ethyl or halogen;
each one of groups from R⁹ to R¹⁴ independently represents hydrogen, linear or branched C₁-C₅ alkyl, halogen, or groups from R⁹ to R¹⁴ are linked each other via alkylene or alkenylene to form a C₅-C₆ spiro-ring or a C₅-C₉ fused ring, or linked with R¹ or R² via alkylene or alkenylene to form a C₅-C₆ fused ring.

5. A phosphor compound according to claim 2, which is selected from the compounds represented by one of Chemical Formulas 5 to 9: 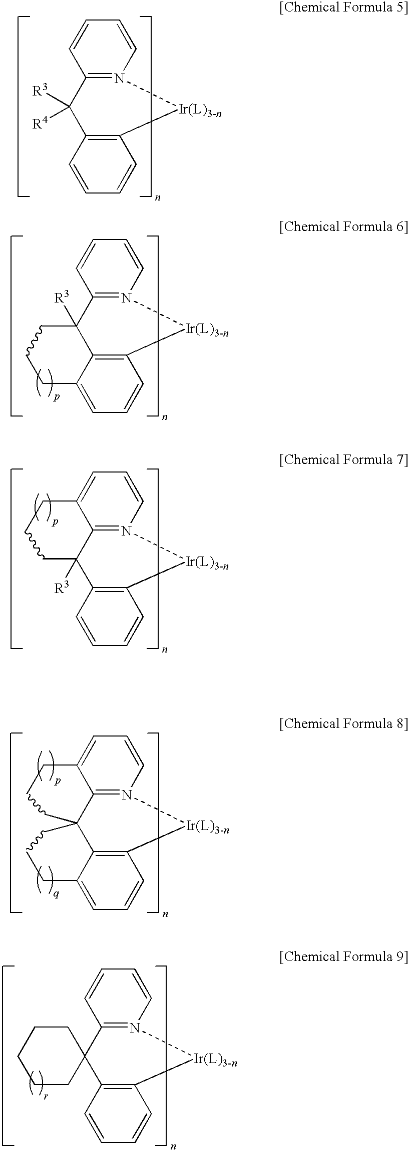
wherein R³ and R⁴ of Chemical Formulas 5 to 7 independently represent hydrogen, methyl, ethyl, n-propyl, i-propyl or fluorine, p, q or r represents 1 or 2, and the dotted line means a single bond or a double bond.

6. A phosphor compound according to claim 3, which is selected from the compounds represented by one of Chemical Formulas 10 to 15: 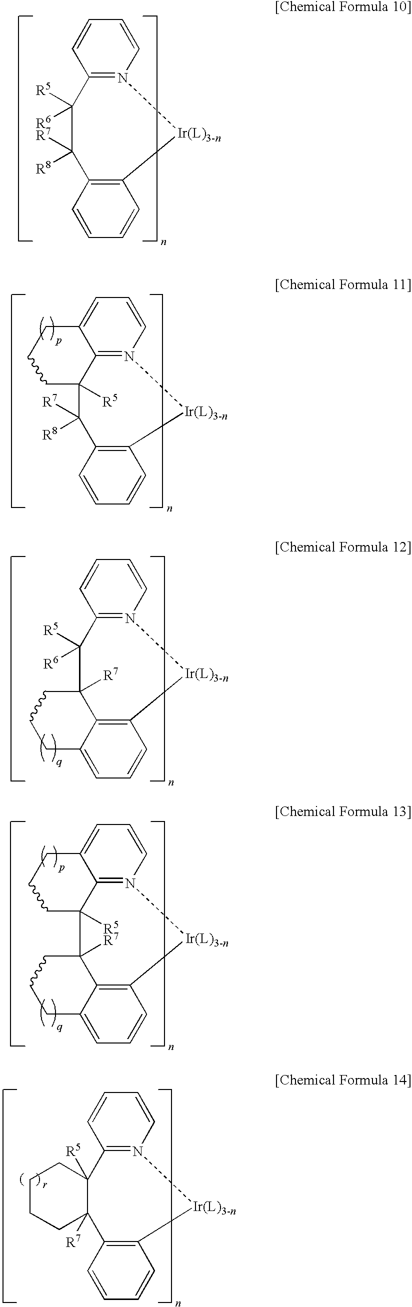 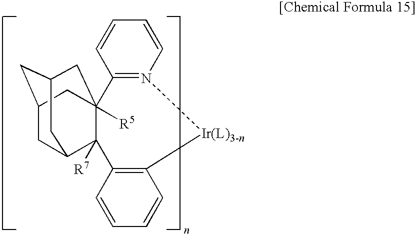
wherein, R⁵ to R⁸ of Chemical Formulas 10 to 15 independently represent hydrogen, methyl, ethyl, n-propyl, i-propyl or fluorine, p, q or r represents 1 or 2, and the dotted line means a single bond or a double bond.

7. A phosphor compound according to claim 4, which is selected from the compounds represented by one of Chemical Formulas 16 to 21: 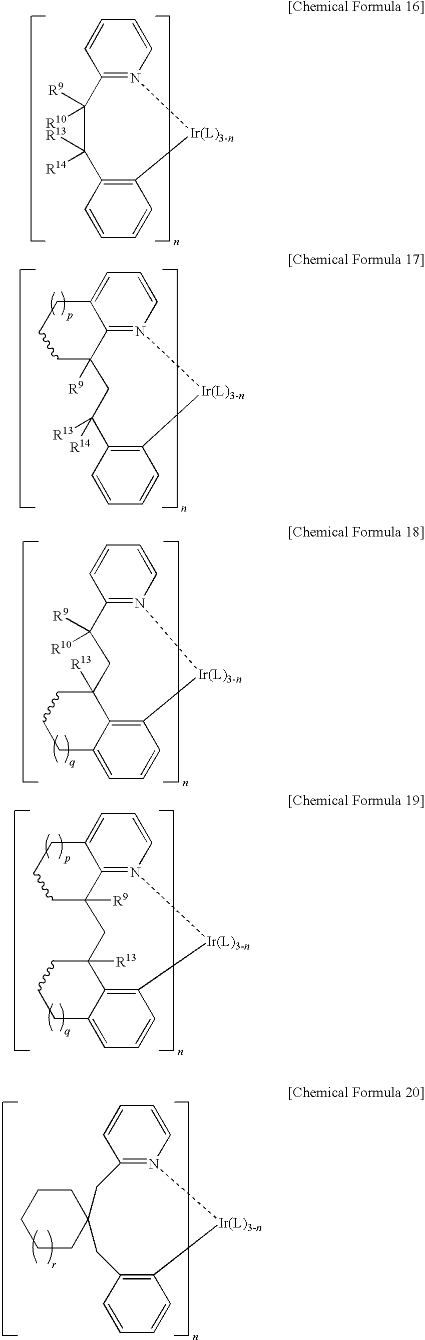 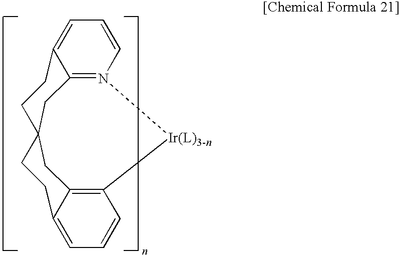
wherein, R⁹ to R¹⁴ of Chemical Formulas 16 to 21 independently represent hydrogen, methyl, ethyl, n-propyl, i-propyl or fluorine, p, q or r represents 1 or 2, and the dotted line means a single bond or a double bond.

8. A phosphor compound according to claim 1, which is represented by one of the following chemical formulas:

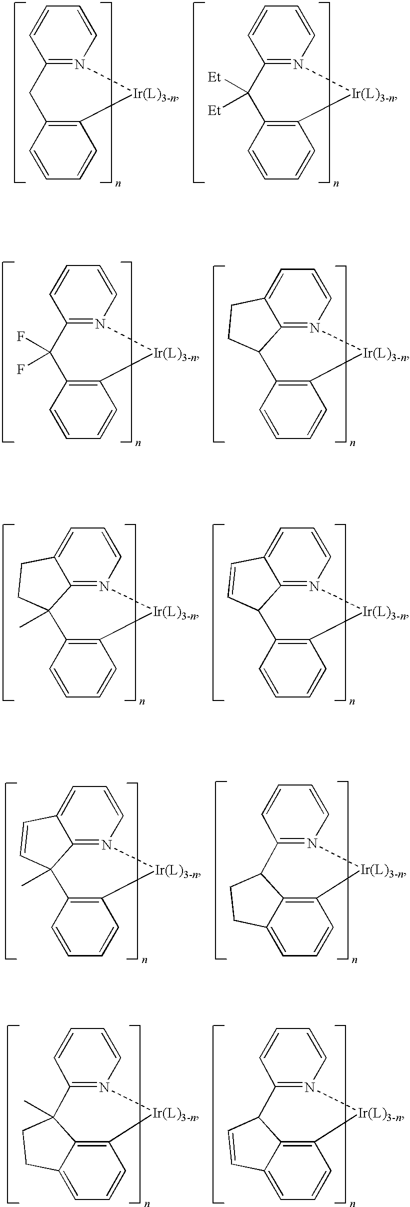

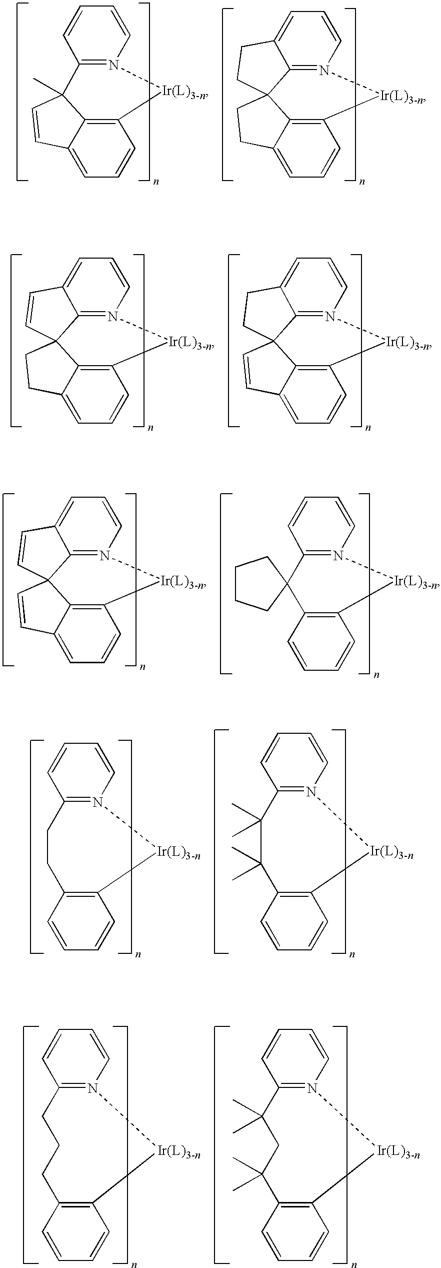

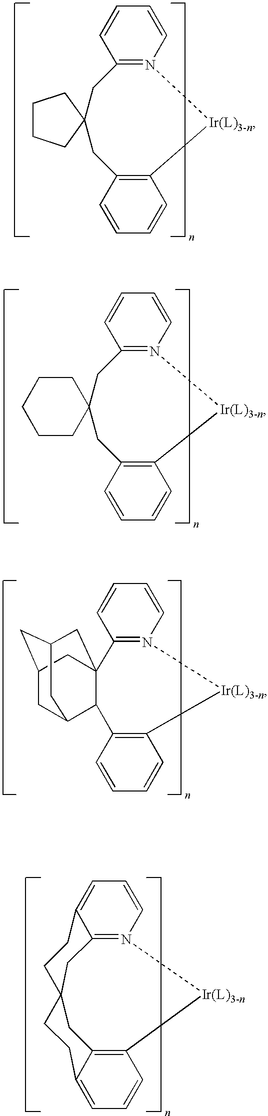

9. A display device comprising a phosphor compound according to one of claims 1 to 8.
